(19) United States
(12) Patent Application Publication
(10) Pub. No.: US 2026/0112819 A1
(43) Pub. Date: Apr. 23, 2026

(54) High Density Packing for Dual-Band Interleaved Array Antennas

(71) Applicant: SN Space Systems Limited, Long Beach, CA (US)

(72) Inventors: Shafaq Kausar, Artesia, CA (US); Maxim Clarke, Long Beach, CA (US)

(73) Assignee: SN Space Systems Limited, Long Beach, CA (US)

(21) Appl. No.: 19/224,344

(22) Filed: May 30, 2025

Related U.S. Application Data
(60) Provisional application No. 63/708,969, filed on Oct. 18, 2024.

(51) Int. Cl. H01Q 21/06; H01Q 1/28; H01Q 5/30

(52) U.S. Cl. CPC H01Q 21/065; H01Q 1/288; H01Q 5/30

(57) ABSTRACT

An array of antenna elements has a first set of antenna elements having extending legs and configured to operate at a wavelength of λ. A second set of antenna elements having extending legs is interspersed among the first set of antenna elements with a desired configuration. The second set of elements is shifted and rotated with respect to the first set of elements such that legs of elements in the second set are disposed between legs of elements in the first set. The spacing between elements of the first set and immediately adjacent elements of the second set is, for example, between 0.3λ and 1λ.

### BACKGROUND OF THE INVENTION

U.S. Pat. App. No. 63/708,969, filed 18 Oct. 2024 is incorporated herein by reference.

### FIELD OF THE INVENTION

The present invention relates to array antennas capable of operating at multiple frequencies simultaneously. In particular, the present invention relates to dual-band interleaved array antennas with high density packing of antenna array elements.

### DISCUSSION OF RELATED ART

Array antennas capable of operating at multiple frequencies simultaneously are highly desirable for various communication systems, particularly in communications satellites where size, weight, and power (SWAP) are critical considerations. One common approach to achieving dual-band functionality is the interleaving of array elements, wherein the antenna surface contains multiple grids of elements, each grid operating at a different frequency. This method allows the antenna to share an aperture, effectively reducing the need for multiple antennas.

However, interleaved array antennas typically face significant design challenges. The spacing between elements of a given set often exceeds the optimal spacing, which can lead to performance issues, including the production of grating lobes, especially at high scan angles, reduced directivity, and a degraded signal-to-noise ratio. Grating lobes, in particular, are problematic in phased arrays as they cause interference and reduce the overall efficiency and accuracy of the antenna system

### SUMMARY OF THE INVENTION

An improved topology for dual-band interleaved array antennas allows for very tight spacing of elements within each set. This topology significantly improves the performance of the antenna, particularly in terms of reducing grating lobes and increasing the available scan angle. The topology is particularly suitable for Low Earth Orbit (LEO) satellite communication payload applications, where dual-band functionality can greatly reduce SWAP while enhancing communication capabilities. Embodiments of the invention use multi-leg type array elements and align the two sets of elements such that the ends of the legs of at least one set of elements occupies the space between the legs of the other set of elements. This approach allows for a reduction in spacing between elements of each set while maintaining the diameter of the elements and maintaining the spacing that is necessary to mitigate coupling between the two element sets.

The spacing between elements of a given set is set to on the order of λ/2, or between, for example, 0.3λ and 1λ depending on desired scan range, cross-polarization performance, size of the antenna and other factors.

This solution is especially useful when the two sets operate at proximal frequencies (generally within a factor of two of each other). This is because the elements of both sets will have similar requirements for diameter and spacing.

In one embodiment, a first set of elements are formed on a plane and have four legs extending outward from the center of the elements. The second set of elements formed on the plane, also have four legs extending outward, and are arranged such that legs of elements in the second set extend into the spaces between legs of elements in the first set, towards the centers of the elements in the first set. A way to visualize this set up is as follows:

A first embodiment uses two grids, one for each set of elements. The grid cells are four-sided, for example square or rectangular. The grids are placed relative to each other such that the vertices of the second grid lie approximately in the center of the cells defined by the first grid.

The first set of elements are four legged (e.g. crossed dipole) and are arranged on the vertices of the first grid. The legs radiate from the center of the element towards surrounding vertices of the first grid.

Similarly, the second set of elements are four-legged and are centered on vertices of the second grid, with legs radiating towards surrounding vertices of the first grid.

They are rotated about 45° compared to the first set of elements. This results in legs of elements in the second set extending into spaces between legs of elements in the first set.

Another embodiment has triangular grid cells and elements with three legs. Again, the second set of elements is arranged so that their legs extend into the spaces between legs of the first set of elements.

The elements may include additional geometric features such as protrusions from the center of the elements or from the legs of the elements.

### BRIEF DESCRIPTION OF THE DRAWINGS

FIG. 1 is a schematic diagram showing two offset four-sided grids for placing a first set of elements and a second set of elements.

FIG. 2 is a schematic block diagram showing a first set of elements placed on the first grid.

FIG. 3 is a schematic block diagram showing the second set of elements placed on the second grid.

FIG. 4 is a schematic block diagram showing the two four-sided grids and respective elements overlaid.

FIG. 5 is a schematic block diagram showing two offset triangular grids for placing a first set of elements and a second set of elements.

FIG. 6 is a schematic block diagram showing a first set of elements placed on the first grid.

FIG. 7 is a schematic block diagram showing the second set of elements placed on the second grid.

FIG. 8 is a schematic block diagram showing the two three-sided grids and respective elements overlaid.

FIG. 9 is a schematic side cutaway diagram showing a printed circuit board embodiment.

FIG. 10 is a schematic side cutaway diagram showing a metasurface antenna embodiment.

FIG. 11 is a schematic diagram showing varying orientations of elements.

FIG. 12 is a schematic block diagram showing two four-sided grids and respective elements overlaid with additional geometric features on the elements.

FIG. 13 is a schematic block diagram showing two three-sided grids and respective elements overlaid with additional geometric features on the elements.

### DETAILED DESCRIPTION OF THE INVENTION

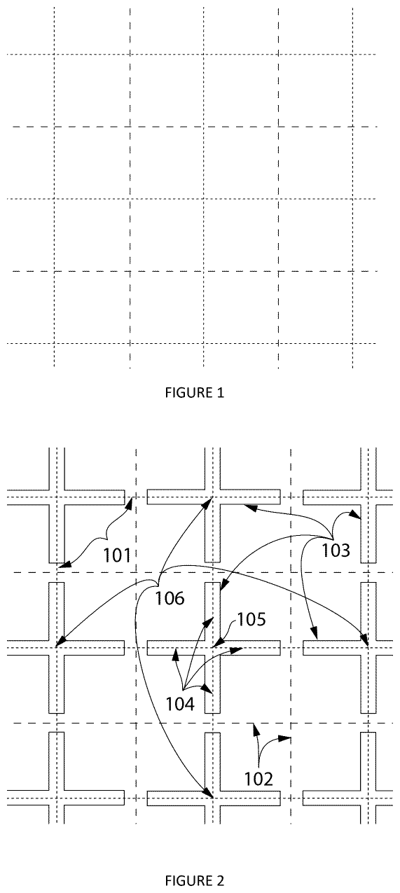

FIGS. 1 through 4 illustrate the core features of an embodiment of the invention.

FIG. 1 shows two grids. The grid 101 with the finely dashed lines is the placement grid for the first set of elements 103, and the grid 102 with the coarsely dashed lines is the grid for the second set of elements 201. The grids are placed relatively to each other such that the vertices of the second grid 102 lie approximately in the center of the cells defined by the first grid 101 and vice versa.

FIG. 2 shows the first set of elements 103 arranged on the vertices of the first grid 101. This shape of element is commonly referred to as a “crossed dipole” or “four-legged element”. A crossed dipole can have variations in geometry to achieve specific performance characteristics, but they are generally characterized by having four distinct conductors (further referred to as “legs 104”, although they are also commonly referred to as “arms”) that radiate from the center 105 of the element 103 at approximately right angles to each other. These figures show a generalized representation of the form of a crossed dipole for the purpose of describing the invention, which is the arrangement of the elements. The representational elements in this embodiment are rotationally symmetric with a period of 90 degrees. The legs 104 of the elements of the first set 103 are aligned such that they point towards the nearest vertices of the grid that defines the placement of the first set of elements 106. This could also be described as legs of the elements of the first set being aligned such that their ends are near to the ends of the legs of adjacent elements of the first set.

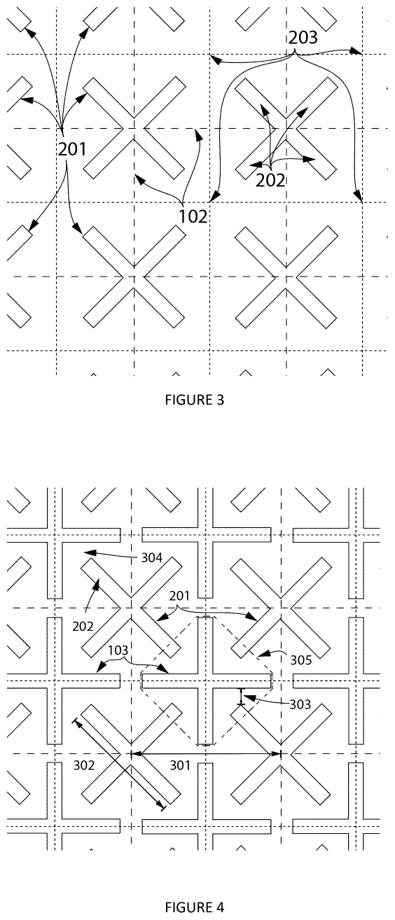

FIG. 3 shows the second set of elements 201 arranged on the vertices of the second grid 102. The second set of elements 201 also take the shape of a crossed dipole. However, the legs 202 of the elements 201 of the second set are aligned with the nearest vertices 203 of the placement grid 101 of the first set of elements 103. The second set of elements 201 are rotated by approximately 45 degrees relative to the second placement grid 102. This could also be described as the legs 202 of the elements 201 of the second set being aligned such that their ends are near to the centers 105 of the adjacent elements 103 of the first set.

FIG. 4 shows what the array looks like when both sets of elements are in place.

The result is that both first set 103 and second set 201 of elements are able to maintain tight element spacing 301 relative to the diameter 302 of the elements 201 without the elements of either set coming into too close of proximity with each other. Generally, interleaved array antennas require a minimum gap 303 between the elements of each set to prevent them from electromagnetically coupling with each other. Rotating the second set of elements 201 relative to the first set 103 allows for the legs 202 of the second set of elements 201 to extend into the gap 304 between the legs 104 of the first set of elements, which allows for tighter element spacing 303 than if the legs of both sets of elements were aligned parallel to each other or if the elements had different shapes such as squares or circles. This could also be described as the legs 202 of the second set of elements 201 extending into the interior region of the convex polygons 305 that minimally circumscribe the elements of the first set.

Having two grids is helpful in understanding the element placement. Another way of looking at this embodiment considers one grid which has vertices forming cells between the vertices. A pattern of array elements has a first set of multi-legged antenna elements having extending legs. The first set of elements is laid out centered on vertices of the grid pattern, and the extending legs of the first set of elements are generally aligned with their closest surrounding vertices. The second set of elements has their extending legs interspersed among the first set of antenna elements such that the second set of elements are generally centered within the cells of the grid pattern, and the extending legs of the second set of elements are generally aligned with their closest vertices of the grid pattern.

In this embodiment the elements have evenly spaced legs, each of equal length.

In this example the grid pattern is a quadrilateral grid pattern, and the elements comprise four legs. As shown and discussed below, a single triangular grid may be considered in the same manner for three-legged elements.

FIGS. 5 through 8 illustrate the core features of an alternative embodiment of the invention.

FIG. 5 shows two grids. The grid 501 with the finely dashed lines is the placement grid for the first set of elements 503, and the grid 502 with the coarsely dashed lines is the grid for the second set of elements 601. The grids are placed relatively to each other such that the vertices of the second grid 502 lie in the center of the cells of the first grid 501 and vice versa.

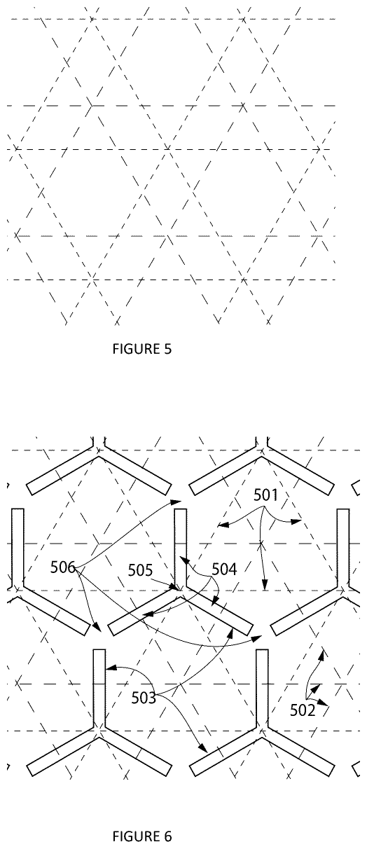

FIG. 6 shows the first set of elements 503 arranged on the vertices of the first grid 501. This shape of element is commonly referred to as a “three-legged element”. A three-legged element can have variations in geometry to achieve specific performance characteristics, but they are generally characterized by having three distinct conductors (further referred to as “legs 504”, although they are also commonly referred to as “arms”) that radiate from the center 505 of the element 503 at approximately 120 degrees to each other. These figures show a generalized representation of the form of a three-legged element for the purpose of describing the invention, which is the arrangement of the elements. The legs 504 of the elements 503 of the first set are aligned such that they point towards the centers 506 of the triangular cells of the first grid 501 that are not occupied by the vertices of the second grid 502.

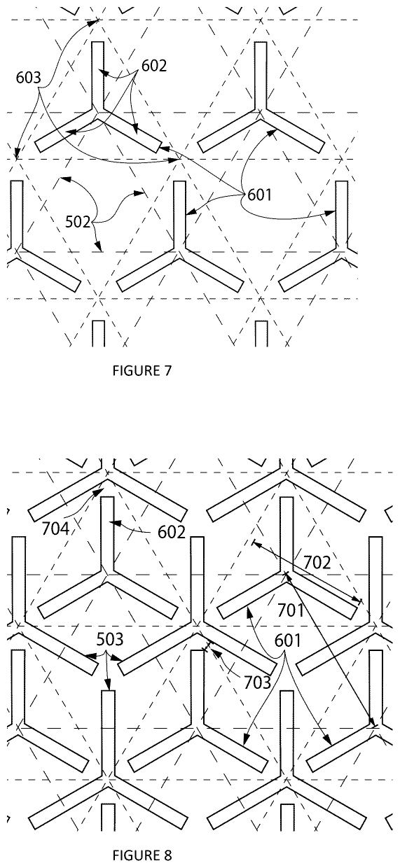

FIG. 7 shows the second set of elements 601 arranged on the vertices of the second grid 502. The second set of elements also take the shape of a three-legged element. However, the legs 602 of the elements 601 of the second set are aligned with the nearest vertices 603 of the placement grid 501 of the first set of elements 503. The second set of elements 601 have approximately the same rotational alignment of its legs as the first set of elements 503.

FIG. 8 shows what the array looks like when both sets of elements are in place.

The result is that both first set 503 and second set 601 of elements are able to maintain tight element spacing 701 relative to the diameter 702 of the elements 601 without the elements of either set coming into too close of proximity with each other. Generally, interleaved array antennas require a minimum gap 703 between the elements of each set to prevent them from electromagnetically coupling with each other. This arrangement of interleaved elements allows for the legs 602 of the second set of elements 601 to extend into the gap 704 between the legs 504 of the first set of elements 503, which allows for the tight element spacing 701.

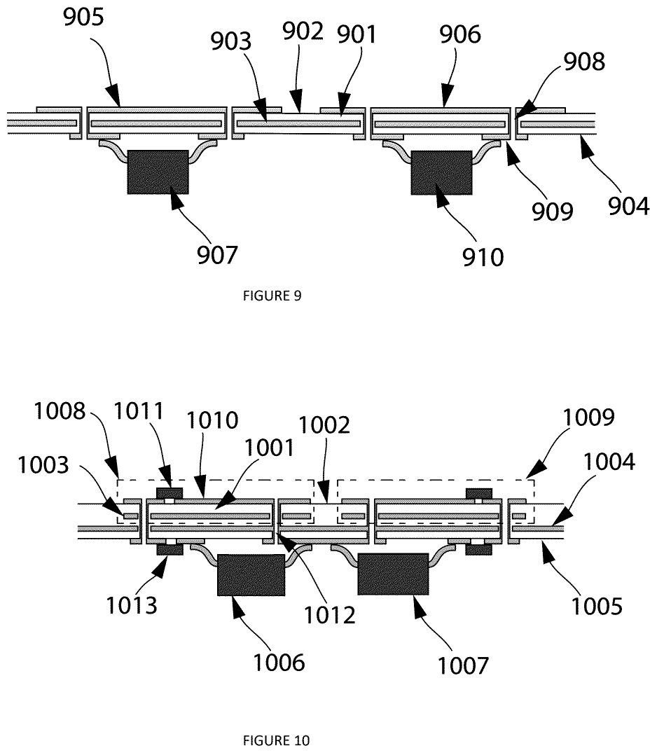

FIG. 9 is an embodiment incorporated into a printed circuit board (PCB)-based direct-radiating phased array antenna from the point of view of a cross-section of the PCB 901. The PCB has three layers. The top layer 902 comprises the first and second sets of elements, which exist as, for example, microstrip or copper patch antennas. The internal layer is the ground plane 903 of the antenna and the bottom layer 904 acts as an interface for the electronic components that are driving the antenna. The figure shows one element 905 from a first set of elements and one element 906 from a second set of elements as copper patches on the top surface of the antenna.

The element 905 from the first set is connected to a first electronic component 907 that is populated on the bottom layer 904 of the PCB by way of two through-hole vias 908 that bypass the ground plane 903 as well as a copper pad 909 on the bottom layer 904 of the board. The first electronic component 907 is part of or potentially the entirety of the transmit chain for that element. In a phased array, the transmit chain of an element performs the functions of frequency conversion, phase modulation and amplification (in multiple possible orders) of the radio signal to be transmitted such that the antenna element is appropriately excited to transmit the desired radio signal. In this embodiment, every element 905 of the first set is connected to a different transmit chain. There are many, many ways to configure how phased array elements are controlled and driven. This invention is relevant for all of them. During operation of the antenna, the amount of phase modulation and potentially the amount of amplification of every element are controlled to produce the desired resulting transmitted beam shape and gain of the array antenna. In an analog beamforming phased array, phase control is achieved using an electronic circuit that changes the phase of an input radio signal. In a digital beamforming phased array, phase control is achieved in the digital domain before modulation of the signal. The pair of connecting vias 908 between the first electronic component 907 and element 905 from the first set allow for control of the polarization (vertical, horizontal, right hand circular or left hand circular) of the transmitted signal through control of the relative phase of the transmitted power between the two connection points.

The element 906 from the second set is connected to a second electronic component 910 that is populated on the bottom layer 904 of the PCB by way of a through-hole via 908 that bypasses the ground plane 903 as well as a copper pad 909 on the bottom layer of the board 904. The second electronic component 910 is part of or potentially the entirety of the receive chain for that element 906. In a phased array, the receive chain of an element performs the functions of frequency conversion, phase modulation and amplification (in multiple possible orders) of the radio signal that is received by the element. In this embodiment, every element of the second set is connected to a different receive chain. The resulting signal from all of the receive chains are combined to produce the net received signal from the antenna. During operation of the antenna, the amount of phase modulation and potentially the amount of amplification of every element are controlled to produce the desired resulting receive beam shape and gain of the array antenna. In an analog beamforming phased array, phase control is achieved through the use of an electronic circuit that changes the phase of an input radio signal. In a digital beamforming phased array, phase control is achieved in the digital domain after demodulation of the signal. The pair of connecting vias 908 between the second electronic component 910 and the element 906 from the second set allow for control of the polarization (vertical, horizontal, right hand circular or left hand circular) of the received signal through control of the relative phase of the received power between the two connection points.

Possibly both sets of components could be configured to receive or transmit, although it would be under a narrow set of circumstances because of the way that transmit bands and receive bands are allocated. It alternates between transmit band and receive band, so the odds of having a second band that is far enough from the first band to not resonate but still close enough for the invention to be relevant (e.g. within a factor of two) is low.

FIG. 10 depicts an embodiment using a metasurface antenna design. The figure shows how the invention could be incorporated into a printed circuit board (PCB)-based reconfigurable reflectarray from the point of view of a cross-section diagram of the PCB 1001. The PCB has 4 layers. The top layer 1002 comprises the first layer of the first and second sets of elements, which exist as microstrip or copper patch antennas in the form of printed circuit board traces. The second layer 1003 comprises the second layer of elements that can be included in the design to improve antenna performance characteristics such as bandwidth or phase range.

The third layer is the ground plane 1004 of the antenna and the bottom layer 1005 acts as an interface for the electronic components 1006, 1007 that are controlling the steering of the antenna. The figure shows one element stack 1008 from the first set and one element stack 1009 from the second set as copper patches on the top surface and in the second layer of the antenna.

The upper element 1010 from the first set comprises two copper patches (or traces) that are bridged by a first varactor diode 1011. One of the copper traces is tied to the ground plane 1004 by a plated via 1012 that bypasses the element on the second layer 1003. The second copper trace is tied to a first electronic component 1006 through a via 1012 that bypasses the element on the second layer and the ground plane and an inductor 1013. The first electronic component 1006 drives the second copper trace with a variable DC voltage relative to the ground plane 1004 to bias the varactor diode 1011 and control the phase response of the first element 1008.

The second element stack 1009 and second electronic component 1007 operate in the same fashion as the first element stack 1008 and first electronic component 1006, the difference being that the first 1008 and second 1009 element stacks have different geometries such that they resonate at different frequencies.

The disclosed embodiments do not entail the full set of possible embodiments of the inventions. Other examples include are non-steering direct-radiating and reflectarray antennas as well as other metasurface antenna types such as transmitarray antennas and reconfigurable reflectarray antennas that use other means of element phase response control.

The above figures show the elements perfectly aligned, which results in optimal spacing. However, as long as the elements are generally aligned, performance can be acceptable. Generally aligned might be within a degree, within 5 degrees, within 10 degrees, within 20 degrees, or within 22.5 degrees of perfectly aligned.

Generally central means having a center somewhere within a small polygon that is defined as a ⅓ scale polygon of the polygon in question, the small polygon sharing a centroid with the polygon in question. The small polygon could also be in the range of ¼ scale, ⅙ scale, ⅛ scale, etc.

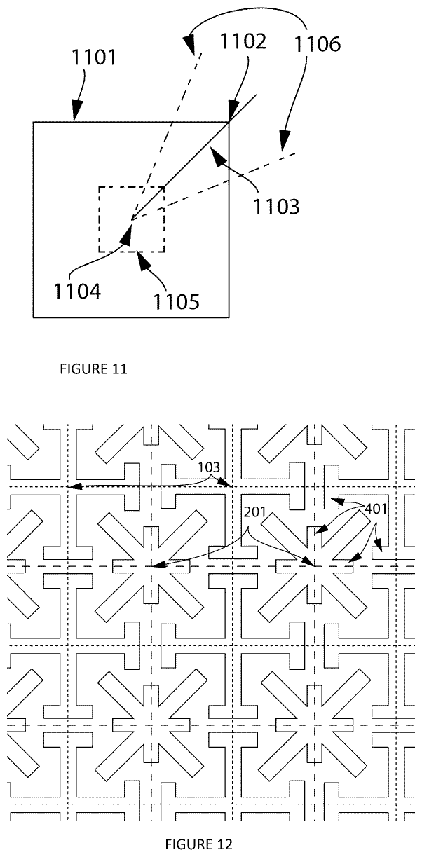

FIG. 11 illustrates both of these concepts. If the large square 1101 in the image is the polygon in question, the upper right vertex 1102 of the large square 1101 is the alignment reference, and the solid line 1103 represents perfect alignment from the exact center of the polygon (being the centroid of the polygon) 1104 to the alignment reference 1102, then the small polygon, dashed square 1105, that is in this example ⅓ scale of the large square 1101 and shares its centroid represents an example of the region that qualifies as generally central and the dashed lines radiating from the center 1106 represent a range of angular deviation from perfect alignment that might qualify as generally aligned.

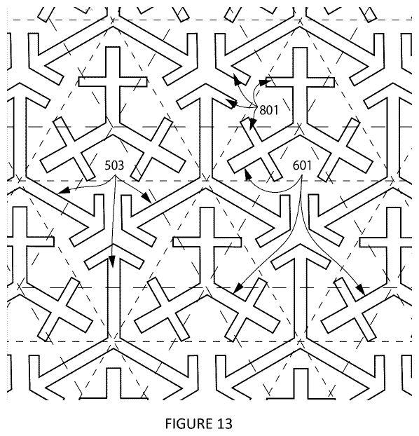

FIGS. 12 and 13 illustrate variations on the configuration of elements such as branching features. The geometry of both sets of elements can theoretically be modified in many ways while still falling within the scope of the invention. FIG. 12 shows a potential embodiment of the invention wherein both sets of four-legged elements 103, 201 have additional geometrical features 401 compared to the generalized version shown in FIG. 4. Additional geometrical features 401 like this can modify the properties of the elements such as changing their resonant frequency or their effective bandwidth. In the case of FIG. 12, the additional features make strategic use of the remaining available space in the array and could serve to differentiate the harmonic response of the two sets of elements. Variations on the invention can also include the addition of discrete electrical components, vias or features that extend in or out of the central plane of the array. Variations on the invention can also be made of a variety of materials such as a printed circuit board, slotted metal plate, or an arrangement of individual antenna structures.

FIG. 13 shows a potential embodiment of the invention wherein both sets of elements 503, 601 have additional geometrical features 801 compared to the generalized version shown in FIG. 8. Additional geometrical features 801 like this can modify the properties of the elements such as changing their resonant frequency or their effective bandwidth. In the case of FIG. 13, the additional features make strategic use of the remaining available space in the array and could serve to differentiate the harmonic response of the two sets of elements. Variations on the invention can also include the addition of discrete electrical components, vias or features that extend in or out of the central plane of the array.

While the exemplary preferred embodiments of the present invention are described herein with particularity, those skilled in the art will appreciate various changes, additions, and applications other than those specifically mentioned, which are within the spirit of this invention. For example, variations can include the addition of discrete electrical components, vias or features that extend in or out of the central plane of the array. Variations on the invention can also be made of a variety of materials such as a printed circuit board, slotted metal plate, or an arrangement of individual antenna structures. The pattern of array elements may comprise multiple layers with each layer having interspersed antenna elements. The pattern of array elements may include circuitry to feed the antenna elements at more than one point. The embodiments shown illustrate the use of regular (the cells of the grid having the shape of regular polygons) and congruent (all cells in the grid having the same shape) grids. Variations of the invention can include the use of irregular (having cells that do not have the same angle at all corners or the same length on all edges) and/or non-congruent (having cells that are a variety of polygon shapes) grids.

What is claimed is:

1. A pattern of array elements comprising:
a first set of multi-legged antenna elements having extending legs and configured to operate at a wavelength of λ;
wherein the first set of elements is laid out in a grid pattern having vertices forming cells, such that the first set of elements are generally centered on vertices of the grid pattern, and the extending legs of the first set of elements are generally aligned with their closest surrounding vertices; and
a second set of elements having extending legs interspersed among the first set of antenna elements and configured to operate at a wavelength other than λ;
wherein the second set of elements are generally centered within the cells of the grid pattern, and the extending legs of the second set of elements are generally aligned with their closest vertices of the grid pattern.

2. The pattern of array elements of claim 1 wherein the grid pattern is a quadrilateral grid pattern, and the elements comprise four legs.

3. The pattern of array elements of claim 1 wherein the grid pattern is a triangular grid pattern, and the elements comprise three legs.

4. The pattern of array elements of claim 1 wherein at least some of the antenna elements comprise traces on a printed circuit board.

5. The pattern of array elements of claim 1 wherein at least some of the antenna elements have rotational symmetry about their centers.

6. The pattern of array elements of claim 1 wherein the second set of antenna elements are configured to operate at a wavelength within a factor of two of λ.

7. The pattern of array elements of claim 1 wherein the antenna elements in the first set and the antenna elements in the second set each have evenly spaced legs.

8. The pattern of array elements of claim 1 wherein the legs of antenna elements in the first set are of equal length.

9. The pattern of array elements of claim 1 wherein the legs of antenna elements in the first set have branching features.

10. The pattern of array elements of claim 1 configured to form a metasurface antenna.

11. The pattern of array elements of claim 1 comprising multiple layers, each layer having interspersed antenna elements.

12. The pattern of array elements of claim 1 further comprising varactors that are configured control the phase response of elements when the varactors are biased with variable DC voltage.

13. The pattern of array elements of claim 1 configured to form a beamforming phased array.

14. The pattern of array elements of claim 1 further comprising circuitry to feed the antenna elements at more than one point.

15. The pattern of array elements of claim 1 configured to form part of a satellite.

16. A method of tightly packing a patterned array of elements comprising the steps of:
placing a first set of antenna elements having extending legs and configured to operate at a wavelength of λ in a grid pattern having vertices forming cells, such that the first set of elements are generally centered on vertices of the grid pattern, and the extending legs of the first set of elements are generally aligned with their closest surrounding vertices; and
interspersing a second set of antenna elements having extending legs and configured to operate at a wavelength other than λ among the first set of antenna elements such that the second set of elements are generally centered within cells of the grid pattern, and the extending legs of the second set of elements are generally aligned with the closest vertices of the grid pattern.

17. The method of claim 16 wherein the second set of antenna elements are configured to operate at a wavelength within a factor of two of λ.

18. The pattern of array elements of claim 17 wherein the grid pattern is a quadrilateral grid pattern, and the elements comprise four legs.

19. The pattern of array elements of claim 17 wherein the grid pattern is a triangular grid pattern, and the elements comprise three legs.

20. A pattern of array elements comprising:
a first set of antenna elements having extending legs and configured to operate at a wavelength of λ; and
a second set of antenna elements having extending legs and configured to operate at a wavelength within a factor of two of λ and interspersed among the first set of antenna elements;
wherein the second set of elements is shifted and rotated with respect to the first set of elements such that legs of elements in the second set are disposed between legs of elements in the first set and generally aligned with centers of elements in the first set.
